(19) United States
(12) Patent Application Publication
(10) Pub. No.: US 2014/0301031 A1
(43) Pub. Date: Oct. 9, 2014

(54) APPARATUS AND METHOD FOR COOLING RANDOM-ACCESS (RAM) MODULES

(71) Applicant: Parker-Hannifin Corporation, Cleveland, OH (US)

(72) Inventors: Timothy Douglas Louvar, Fort Wayne, IN (US); Jessica Anne Hunnicutt, Markle, IN (US)

(21) Appl. No.: 14/356,271

(22) PCT Filed: Nov. 11, 2012
(86) PCT No.: PCT/US2012/063527

§ 371 Date: May 5, 2014

Related U.S. Application Data
(60) Provisional application No. 61/555,613, filed on Nov. 4, 2011.

(51) Int. Cl. G06F 1/20

(52) U.S. Cl. CPC G06F 1/20
USPC 361/679.31; 361/679.47; 165/80.4

(57) ABSTRACT

An electronic module cooling apparatus and method for cooling a plurality of electronic modules each including a circuit board to which one or more electronic components are mounted, in particular memory modules, disposed on a substrate in spaced-apart parallel relationship. The apparatus and method provide for effective cooling of the electronic modules while still allowing for insertion and removal of the electronic modules from a common substrate and/or providing for biased contact with electrical components of the electronic modules. In a particular embodiment, the apparatus provides for liquid cooling memory boards, allowing heat to be removed from the electronic components that are contained in densely populated enclosures without the need for air flow.

### TECHNICAL FIELD

The present invention relates to thermal management of electronic circuit modules, for example, liquid cooling of random-access memory modules.

### BACKGROUND

Electronic circuit modules are often mounted in one or more rows in a chassis or other enclosure. The modules usually consist of a circuit board to which one or more electronic components are mounted. The modules typically are mounted perpendicular to a planar mounting substrate by card edge connectors that are electrically and/or mechanically connected to mating connectors on the mounting substrate. The cards are usually spaced apart to allow air to flow between the cards for cooling the cards, i.e. removing heat that is generated by electrical components of the modules.

Electronic systems using circuit modules are continually being reduced in size while the heat generated by the electronic modules is increasing. Oftentimes the cooling requirements exceed the available capacity of natural or forced convection cooling.

U.S. Pat. No. 6,687,126 seeks to address the problem of cooling densely packed electronic modules by employing a cooling plate apparatus disposed on a plurality of integrated circuit elements which are disposed on a plurality of circuit boards. A plurality of U-shaped thermally conductive metal plates is enclosed by cooling plate apparatus that is in thermal contact with the closed ends of the U-shaped members that fit over respective electronic modules.

### SUMMARY OF THE INVENTION

The present invention provides an electronic module cooling apparatus and method for cooling a plurality of electronic modules each including a circuit board to which one or more electronic components are mounted, in particular memory modules, disposed on a substrate in spaced-apart parallel relationship. The apparatus and method provide for effective cooling of the electronic modules while still allowing for insertion and removal of the electronic modules from a common substrate and/or providing for biased contact with electrical components of the electronic modules. In a particular embodiment, the apparatus provides for liquid cooling memory boards, allowing heat to be removed from the electronic components that are contained in densely populated enclosures without the need for air flow.

More particularly, an electronic module cooling apparatus and method are characterized by a row of parallel, spaced apart, thermally conductive, cold plates that extend longitudinally and define planar slots that are open top and bottom for receiving respective electronic modules, at least one of the cold plates having a thermally conducting, in particular planar, surface for contacting the one or more electronic components of a relatively adjacent electronic module; and a first fluid conduit providing a passageway for cooling fluid, the first fluid conduit extending along the row of cold plates outwardly in relation to the planar slots, the conduit being connected to adjacent first longitudinal ends of a plurality of the cold plates for transferring heat absorbed by the plurality of cold plates to the cooling fluid flowing through the first conduit.

Each planar slot may be bounded by a respective pair of the cold plates.

Preferably, one or more resilient clips are provided for engaging backsides of the cold plates for squeezing the cold plates together for holding the cold plates tightly against the electronic components of the electronic module received in the planar slot formed between the pair of cold plates.

Each clip may be a U-shape clip having an open end.

Preferably, two or more longitudinally spaced apart clips are used for each to squeeze a respective pair of cold plates.

Preferably, the clip or clips are easily slipped off individually to permit removal of a respective electronic module from the substrate.

Alternatively or additionally, other means and methods may be used for mechanically holding and/or urging the pair of cold plates in thermal contact with the electronic modules.

A front side of each cold plate of the pair of cold plates may have the thermally conducting surface for contacting respective confronting surfaces of the electronic module disposed between the cold plates.

The cold plates preferably include a thermally conductive metal, in particular copper, substrate covered at the thermally conductive surface by a thermally conductive dielectric material.

The thermally conductive dielectric material preferably is resilient for conforming to the confronting surface of the electronic module.

The dielectric material may be in the form of a thin solid film.

The first ends of the plurality of cold plates may be held in spaced apart relationship by the first fluid conduit.

The first fluid conduit may be a tube, and the first ends of the plurality of cold plates preferably have apertures through which the tube passes.

The apparatus preferably includes a second conduit providing a passageway for cooling fluid, and the second conduit may be connected to second longitudinal ends of the plurality of cold plates opposite the first ends.

At least one of the cold plates may include a fluid passage communicating with at least the first conduit for passage of cooling fluid through said one cold plate.

In combination, the plurality of electronic modules may be disposed between respective pairs of the cold plates, and the electronic modules may be removably mounted by module receptacles on a base substrate.

The electronic module cooling apparatus may be mounted to the base substrate independently of the electronic modules, such as by attaching the first and/or second fluid conduits to the base substrate or other supporting structure such as a chassis or other housing.

Preferably, at least of the electronic modules is removable from the base substrate without removing the electronic module cooling apparatus.

The cold plates may be fixed to each fluid conduit by brazing.

According to another aspect of the invention, a cooling module for cooling a memory board includes a first heat absorbing element for removing heat from a memory board, the first heat absorbing element having an elongated surface for thermally contacting a first surface of the memory board. The cooling module also includes a second heat absorbing element for removing heat from the memory board. The second heat absorbing element has an elongated surface for thermally contacting a second surface of the memory board. The elongated surface of the second heat absorbing element faces the elongated surface of the first heat absorbing element and is spaced therefrom to form a space into which the memory board is receivable. A conduit connects the first heat absorbing element and the second heat absorbing element. The conduit provides a passageway for a fluid flow through the cooling module to remove heat absorbed by the first heat absorbing element and the second heat absorbing element.

The cooling module/apparatus can be incorporated into a pumped loop cooling system.

According to another aspect of the invention, a method of cooling a memory board comprises providing a cooling apparatus or module as above set forth; inserting a memory board into the space between the heat absorbing elements; and pumping a fluid through the conduit to remove heat from the heat absorbing elements.

Further features of the invention will become apparent from the following detailed description when considered in conjunction with the drawings.

### BRIEF DESCRIPTION OF THE DRAWINGS

Embodiments of this invention will now be described in further detail with reference to the accompanying drawings, in which:

FIG. 1 is a schematic view of an exemplary embodiment of cooling system having a passive cooling array for cooling a plurality of memory boards;

FIG. 2 is a perspective view of the exemplary passive cooling array assembled to a plurality of memory boards.

FIGS. 3 and 4 are perspective views respectively showing removal and installation of a single memory board in relation to the cooling array;

FIG. 5 is a fragmentary perspective view of the conduit through the cooling array;

FIG. 6 is an exploded perspective view of a preferred cold plate;

FIG. 7 is an exploded perspective view of another cold plate including fluid flow passage(s); and

FIG. 8 is a perspective view showing an exemplary method of mounting the cooling array to a base substrate.

### DETAILED DESCRIPTION

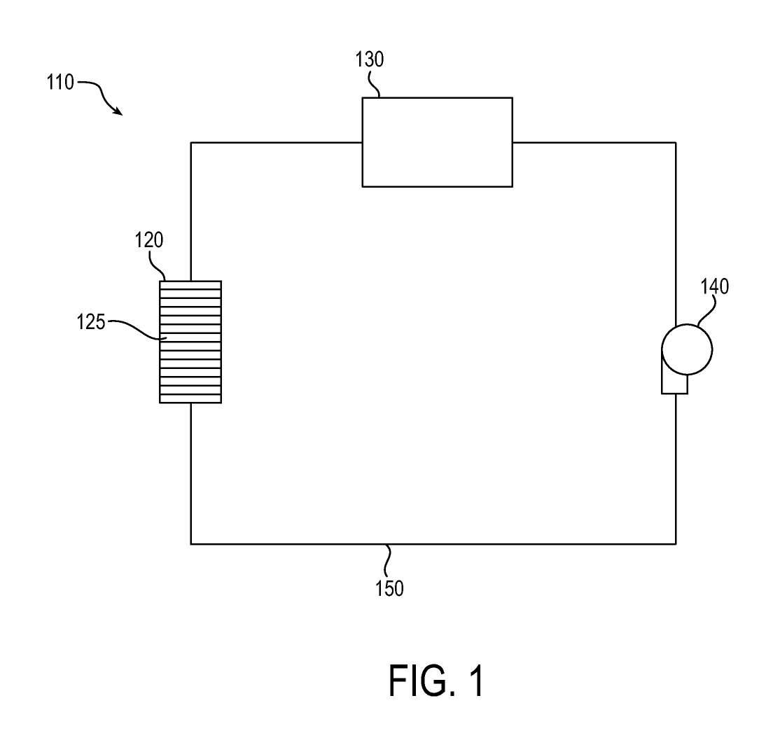

Referring to FIG. 1, a pumped liquid multiphase cooling system 110 is shown. The system 110 includes a cooling module/apparatus 120 as described in more detail below that is in thermal contact with one or more electronic modules 125 (more particularly electronic components of such modules), a heat exchanger 130 for removing heat from the system, and a pump 140 for circulating a cooling media through the system, all of which are connected to each other by fluid circuit conduits 150 to form a fluid cooling circuit 135. A fluid such as water or a refrigerant is pumped through the system 110 to cool the electronic components 125. The heat generated by the electronic component 125 is transferred to the fluid, which may cause the fluid to partially vaporize. The fluid then travels to the heat exchanger 130 wherein the heat is rejected from the system 110 and the fluid returns to the cooling module 120 by way of the pump 140. As will be appreciated, the cooling system may be a multiphase system or a single phase system in which the liquid does not undergo a phase change. The fluid cooling circuit alternatively may include condensers, compressors, expansion valves and evaporators for providing a chilled refrigerant to the cooling apparatus 120.

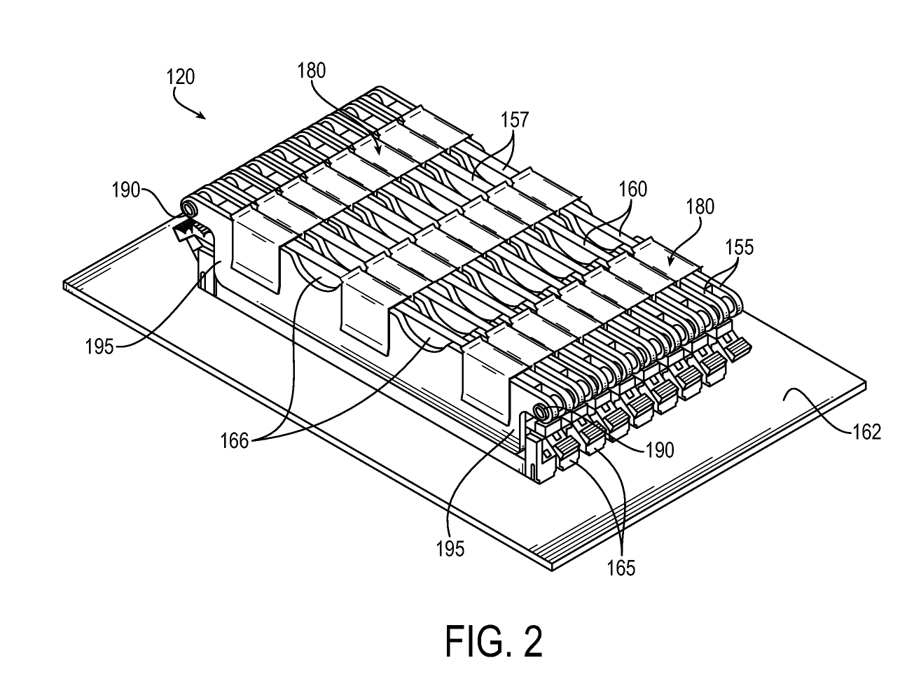

An exemplary embodiment of the cooling apparatus 120, also herein referred to interchangeably as a cooling module, is shown in detail in FIGS. 2-6. The cooling apparatus 120 includes a plurality of thermally conductive and thus heat absorbing planar elements 155 herein referred to as cold plates, which may be formed from metal plates. The cold plates 155 are parallel and spaced apart to form therebetween a plurality of receptacles 157, herein also referred to as slots interchangeably. The slots 157 are open top and bottom for receiving electronic modules 160 such as memory boards. The electronic modules may be mounted, preferably removably, to a base substrate 162 by means of card/board receptacles 165 on the base substrate. The receptacles 165 typically provide a mechanical as well as an electrical interface between the electronic modules and the base substrate. The top edges of the cold plates may have one or more finger recesses 166 to facilitate insertion and removal of the electronic modules.

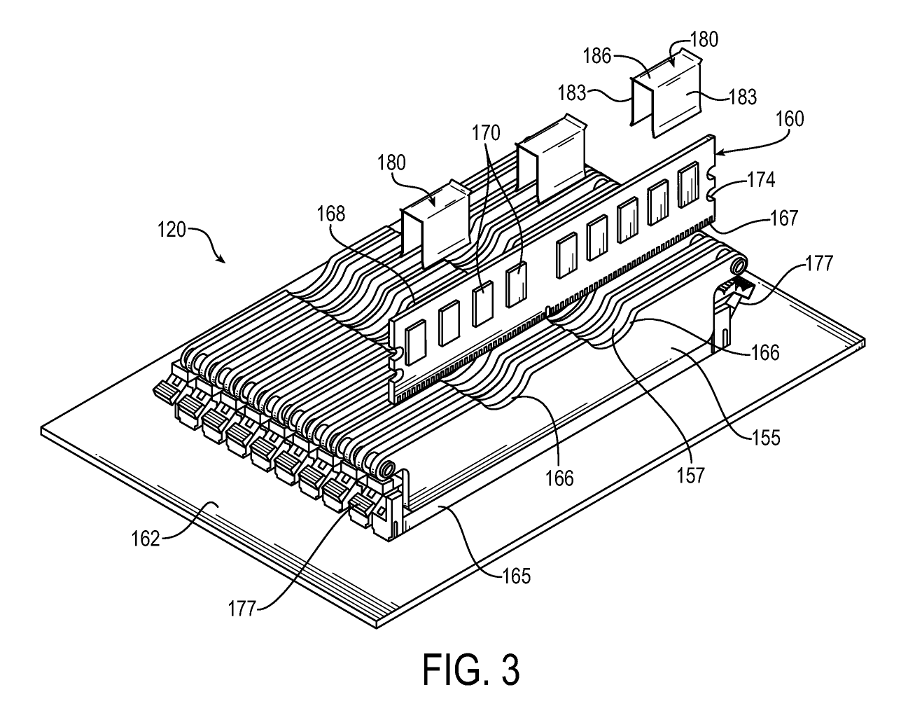

The electronic modules 160 typically are mounted perpendicular to the base substrate 162 by the card edge connectors 167 (FIG. 3) that are electrically and/or mechanically connected to mating connectors/receptacles 165 on the base substrate.

As shown in FIG. 3, the electronic modules 160 each generally have a planar configuration and, as is typical, include a circuit board 168, in particular a printed circuit board, to which one or more electronic components 170 are mounted on one or both sides thereof. In the case of the illustrated memory modules, a coplanar arrangement of memory chips 170 are mounted in respective rows on opposite sides of the circuit board 168. The memory boards may include Random-Access Memory (RAM) modules, for example, SIMM, DIMM, SODIMM, and DRAM modules and the like. Typically the heights of the memory chips will be the same such that the top surfaces thereof are at about the same height and thus in effect coplanar. The bottom edge of each electronic module may be configured to form the card edge connector 167 that can be mated with a corresponding receptacle 165 on the base substrate 162. As is well known, memory modules 160 like those illustrated have retainer notches 174 in the longitudinal ends there that are engaged by upright latch structures 177 at each end of the receptacles for releasably retaining the memory card in the receptacle.

Returning to FIG. 2, the cold plates 155 are configured to be in thermal contact with the electronic modules 160 so as to absorb heat generated by the electronic components of the modules when in operation. Preferably, each electronic module is thermally contacted by a respective pair of cold plates that define the slot 157 in which the electronic module is received.

The cold plates 155 bounding adjacent slots preferably are spaced apart along the lengths thereof or at least at one or more locations to form a space for receiving one or more spring clips 180 that are used to firmly press the cold plates against heat generating components of the modules 160, ensuring good thermal contact between the components. In particular, the spring clip or clips will squeeze the cold plates together for holding the cold plates tightly against respective sides of the electronic module sandwiched therebetween. In the case of the illustrated memory modules, the cold plates will be pressed against the top sides of the memory chips 170 to ensure good thermal contact for efficient absorption of heat from the chips. In the illustrated embodiment, three spring clips are provided and arranged in longitudinally spaced apart relationship, but it will be appreciated that one or any number of clips may be used as desired.

The clips 180 may be U-shape with a pair of depending legs 183 for engaging the backsides of the cold plates 155 and a central bight portion 186 joining the legs at the top end of the legs.

Preferably the clips 180 are made of a resilient material such as spring steel or stainless steel. The clips may be electrically conducting or not electrically conducting depending on the application.

The clip or clips 180 may be located along the cold plates 155 so as not interfere with the finger recesses 166, as shown.

Other means and methods may be used for mechanically holding and/or urging the pair of cold plates in thermal contact with the electronic modules. This could include, but is not limited to, a wedge mechanism, a camming mechanism, another form of a spring mechanism such as the use of helical springs or conical washers, or another means and method known to hold the surfaces in tight contact.

The memory boards 160 are cooled by direct contact between the electronic modules and the adjacent cold plates 155. Although there may be just one pair of cold plates for a single electronic module, typically there will be multiple pairs of cold plates for an array of electronic modules arranged in one or more rows.

The cooling apparatus 120 further comprises one or more fluid conduits 190 connected in the fluid circuit 135 shown in FIG. 1. The fluid conduits cool the cold plates 155 that in turn cool the electronic modules 160. In the illustrated embodiment a fluid conduit is located at each end of the cold plates. Each conduit extends along the row of cold plates outwardly in relation to the planar slots 157. Each conduit is connected to the adjacent longitudinal ends of a plurality of the cold plates for transferring heat absorbed by the plurality of cold plates to the cooling fluid flowing through the conduit. The circulating fluid transfers the heat from the cold plates a desired location elsewhere in the fluid system, in particular the heat exchanger 130 where the heat is removed from the cooling fluid.

The cooling fluid can be water, or refrigerant that is cooler than the steady-state temperature of the cold plates.

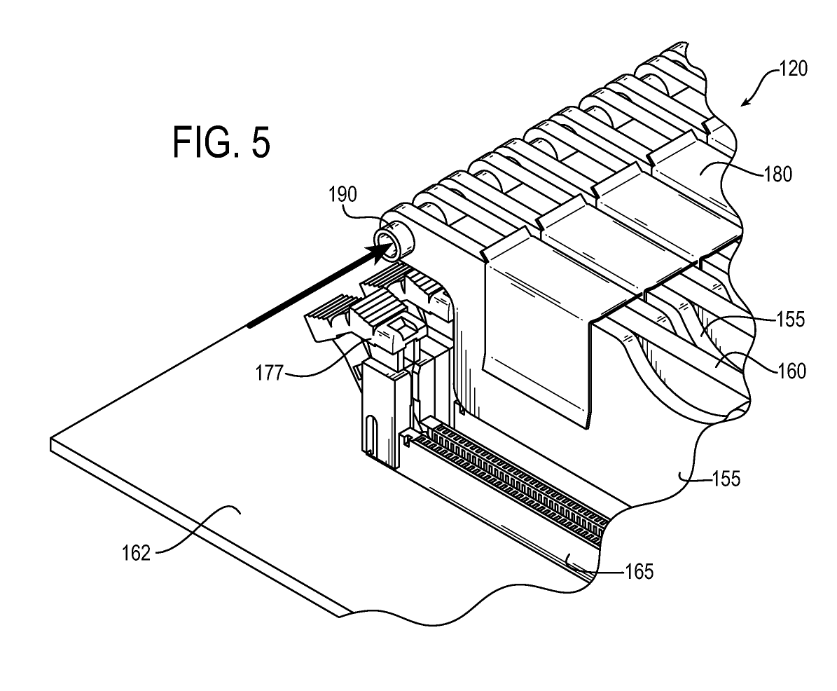

In the illustrated embodiment, the longitudinal ends of the cold plates 155 are held in spaced apart relationship by the fluid conduits 190. As best seen in FIG. 5 (where the apparatus and memory modules are exploded away from the base substrate), the conduits 190 may be tubes, and the longitudinal ends of the cold plates may have apertures through which the tubes pass. The cold plates may be fixed to the tubes by any suitable means, such as by brazing, press fitting, welding or gluing. The connection should provide for good thermal transfer of heat from the cold plates to the tubes for passage to the fluid flowing through the tubes.

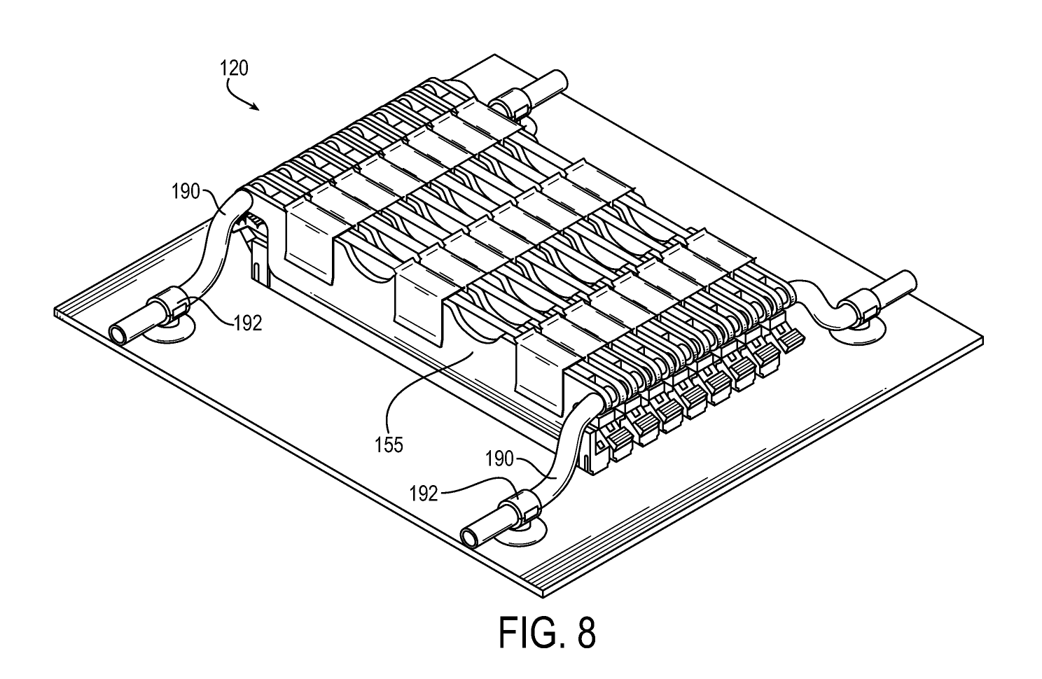

As thus far described, the apparatus 120 may be assembled as a module that can be supported, in particular removably, on the main substrate 162 by any suitable means. For example, the tubes 190 may be used to mount the apparatus to the main substrate by suitable means such as brackets, clips and the like. FIG. 8 shows one such example where the tubes extending beyond the array of cold plates 155 are bent downwardly for attachment by releasable clips 192.

As seen in FIG. 2, the ends of the cold plates 155 may have notched corners 195 for accommodating the latch structures 177 that secure the electronic modules in the receptacles 165.

In addition, the fluid conduits 190 at the ends of the cold plates are spaced outwardly of longitudinal ends of the slots 157 that receive the electronic modules 160 so that the electronic modules may be inserted and removed from the base substrate 162 without having to remove the cooling apparatus. Only the clips 180 need to be removed and reinstalled as discussed below.

As illustrated in FIG. 3, an electronic module 160 can be removed from the base substrate by first removing the clips 180 associated with the cold plates at each side of the electronic module to be removed. Once the clips have been removed, the electronic module can be withdrawn from the slot 157, such as by gripping the electronic module at the finger recesses 166.

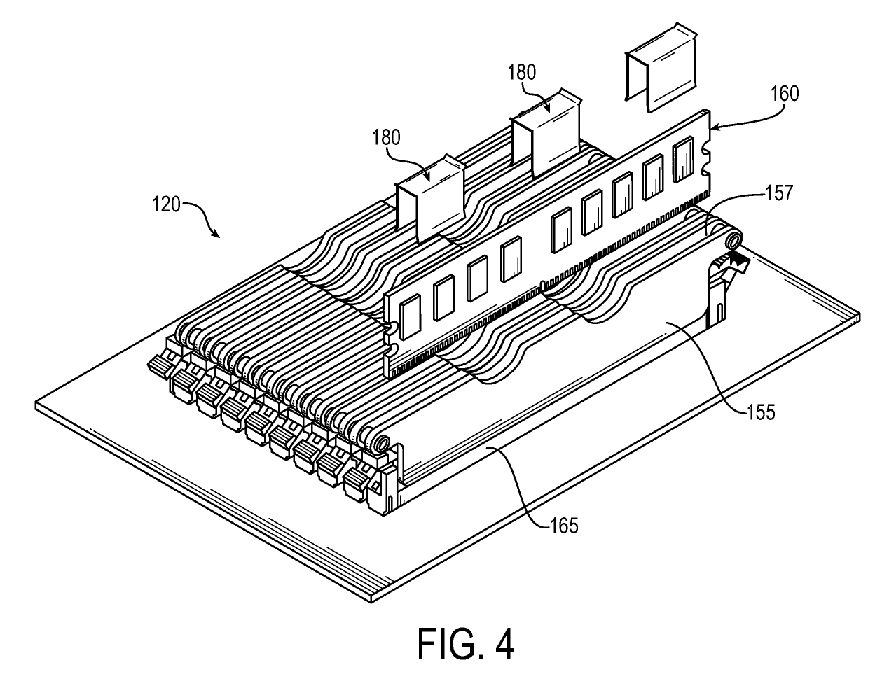

As illustrated in FIG. 4, an electronic module 160 can be installed or reinstalled by inserting the electronic module into an open slot 157 and mating the card edge connector 167 in the receptacle 165 on the base substrate 162.

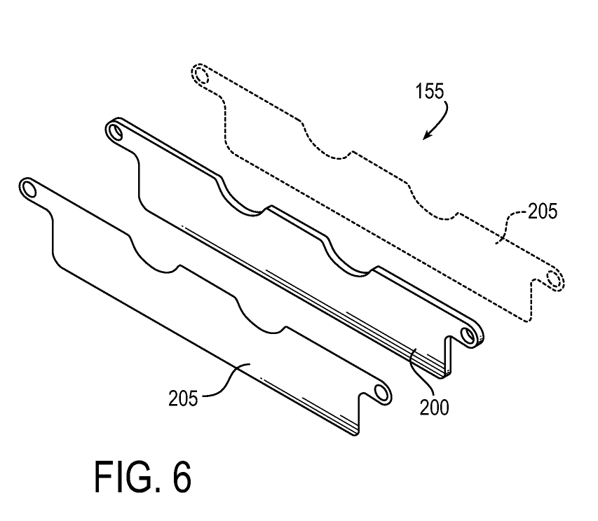

Referring now to FIG. 6, a preferred form of a thermally conductive cold plate 155 is shown. The cold plate includes a substrate 200 made of a material having high thermal conductivity, preferably a metal, such as copper. At least one side (the side for contacting the electronic module) of the substrate is covered by a solid dielectric film 205 such as Kapton polyimide film, Mylar BoPET (Biaxially-oriented polyethylene terephthalate) film or a pre-impregnated epoxy composite film. The film preferably is of corresponding shape and is attached to the substrate, such as by an adhesive. The thermally conductive dielectric material preferably is resilient for conforming to the confronting surface of the electronic module, such as like a Parker THERM-A-GAP thermally conductive gap filler pad. For instance, the outer surfaces of the electronic components may not be exactly at the same height or may be slightly skewed. The resilience of the dielectric film allows the film to conform to the slightly misaligned electronic components, particularly when pressure is applied by the spring clips, in order to provide good surface contact with the outer surfaces of the electronic components for improved thermal transfer.

By way of example, for use with memory modules 160 at a center to center spacing of 0.400 inches, the thermally conductive cold plates 155 may have a thickness of about 0.090 inches. In the case of a cold plate including a substrate and dielectric films on the side surfaces, the substrate (preferably copper) may have a thickness of about 0.070 inch to about 0.080 inch and the dielectric film 205 may have a thickness of about 0.010 inch to about 0.020 inch.

In another embodiment, one or more of the cold plates 155 may include one or more fluid passages communicating with one or more of the conduits for passage of cooling fluid through and along the length of the cold plate or plates. One optional way of doing this is to form the cold plates as a macrolaminate comprising a plurality of juxtaposed layers at least one of which is formed with channels that form the passageways when the layers are assembled together. Another method is to braze or weld two or more plates together, one or more of them containing internal passageways.

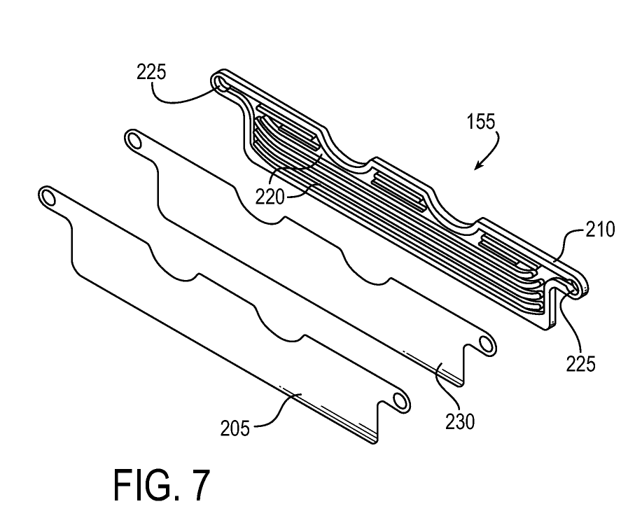

FIG. 7 shows an example of such a cold plate with fluid passages. The cold plate 155 of FIG. 7 includes a first plate 210 having formed in a surface thereof one or more flow passages 220 that communicate via inlet/outlet passages 225 with the apertures through which the fluid conduits 190 pass. The fluid conduits will be provided with holes in the walls thereof to provide from flow from the interior of the fluid conduits to the inlet/outlet passages 225. As illustrated, multiple flow passages may be separated by a network of walls running along the length of the cold plate to provide for desired flow of a cooling fluid across the cold plate. The flow passages 220 are closed by a cover plate 230 that may be suitably joined to the first plate 210 such as by brazing, welding, gluing or other suitable means. As before, the surface of the cold plate intended to contact the electronic module may be provided with a dielectric film 205.

The cold plates may be symmetrical in which case the same cold plate can be used for contacting either side of the electronic module, with one reversed relative to the other. In an alternative arrangement, each side of the cold plate may be provided with the dielectric film.

As will be apparent from the foregoing, a method of cooling an electronic module, in particular a memory board, includes providing a cooling apparatus as described herein, inserting a memory board in to the space between the heat absorbing cold plates, and pumping a fluid through the conduit(s) to remove heat from the heat absorbing elements.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

1. An electronic module cooling apparatus for cooling a plurality of electronic modules, in particular memory modules, disposed on a substrate in spaced-apart parallel relationship, each module including a circuit board to which one or more electronic components are mounted, the apparatus comprising:
a row of parallel, spaced apart, thermally conductive, cold plates that extend longitudinally and define planar slots that are open top and bottom for receiving respective electronic modules, at least one of the cold plates having a thermally conducting, in particular planar, surface for contacting the one or more electronic components of a relatively adjacent electronic module;
a first fluid conduit providing a passageway for cooling fluid, the first fluid conduit extending along the row of cold plates outwardly in relation to the planar slots, the conduit being connected to adjacent first longitudinal ends of a plurality of the cold plates for transferring heat absorbed by the plurality of cold plates to the cooling fluid flowing through the first conduit; and
a second conduit providing a passageway for cooling fluid, wherein the second conduit is spaced apart from the first fluid conduit and is connected to second ends of the plurality of cold plates opposite the first ends.

2. The electronic module cooling apparatus of claim 1, wherein each planar slot is bounded by a respective pair of the cold plates, and means are provided for pressing the cold plates against respective sides of the electronic module received in the planar slot formed between the pair of cold plates.

3. The electronic module cooling apparatus of claim 2, wherein the means for pressing includes a resilient clip for engaging backsides of the cold plates for squeezing the cold plates together for holding the cold plates against respective sides of the electronic module received in the planar slot formed between the pair of cold plates.

4. The electronic module cooling apparatus of claim 2, wherein a front side of each cold plate of the pair of cold plates has the thermally conducting surface for contacting respective confronting surfaces of the electronic module disposed between the cold plates.

5. The electronic module cooling apparatus of claim 1, wherein the cold plates include a thermally conductive resilient dielectric material on surfaces of the cold plates for engaging the memory modules.

6. (canceled)

7. The electronic module cooling apparatus of claim 5, wherein the thermally conductive resilient dielectric material is in the form of a thin solid film.

8. The electronic module cooling apparatus of claim 1, wherein the first and second ends of the plurality of cold plates are held in spaced apart relationship by the first and second fluid conduits.

9-10. (canceled)

11. The electronic module cooling apparatus of claim 1, wherein at least one of the cold plates includes a fluid passage communicating at one end with the first conduit and at an opposite end with the second conduit for passage of cooling fluid through said one cold plate.

12-13. (canceled)

14. The apparatus of claim 1, in combination with the plurality of electronic modules disposed between respective pairs of the cold plates, the combination further comprising a base substrate to which the electronic modules are removably mounted by module receptacles, wherein the electronic module cooling apparatus is mounted to the base substrate independently of the electronic modules.

15. The combination of claim 14, wherein at least of the electronic modules is removable from the base substrate without removing the electronic module cooling apparatus.

16. The apparatus of claim 1, wherein the cold plates are fixed to each fluid conduit by brazing.

17. A cooling module for cooling a memory board, comprising:
a first heat absorbing element for removing heat from a memory board, the first heat absorbing element having an elongated surface for thermally contacting a first surface of the memory board;
a second heat absorbing element for removing heat from a memory board, the second heat absorbing element having an elongated surface for thermally contacting a second surface of the memory board, the elongated surface of the second heat absorbing element facing the elongated surface of the first heat absorbing element and being spaced therefrom to form a space into which the memory board is receivable; and
a conduit connecting the first heat absorbing element and the second heat absorbing element, the conduit providing a passageway for a fluid flow through the cooling module to remove heat absorbed by the first heat absorbing element and the second heat absorbing element; and
wherein means are used to enhance thermal contact between the heat absorbing elements and respective sides of the memory board.

18. The cooling module of claim 17, wherein the first heat absorbing element and the second heat absorbing element are part of an array of heat absorbing elements for absorbing heat from a plurality of memory boards disposed in spaces between the heat absorbing elements in the array.

19. The cooling module of claim 17, wherein the means used to enhance thermal contact includes a clip for sandwiching the memory board between the elongated surface of the first heat absorbing element and the elongated surface of the second heat absorbing element.

20. (canceled)

21. The cooling module of claim 17, further comprising a second conduit connecting the first heat absorbing element and the second heat absorbing element, the second conduit providing a passageway for a fluid flow through the cooling module to remove heat absorbed by the first heat absorbing element and the second heat absorbing element, and wherein the conduits are spaced apart from one another and located at opposite ends of the heat absorbing elements.

22-23. (canceled)

24. The cooling module of claim 17, wherein the heat absorbing elements are brazed to the conduit.

25-27. (canceled)

28. The cooling module of claim 17, in combination with a memory board having a first surface and a second surface, the memory board received in the space between the first heat absorbing element and the second heat absorbing element, wherein the elongated surface of the first heat absorbing element is in thermal contact with the first surface of the memory board and the elongated surface of the second heat absorbing element is in thermal contact with the second surface of the memory board.

29-30. (canceled)

31. A method of cooling a memory board, comprising:
providing a cooling apparatus or module including
a first cold plate for removing heat from a memory board, the first cold plate having an elongated surface for thermally contacting a first surface of the memory board,
a second cold plate for removing heat from a memory board, the second cold plate having an elongated surface for thermally contacting a second surface of the memory board, the elongated surface of the second cold plate facing the elongated surface of the first cold plate and being spaced therefrom to form a slot into which the memory board is receivable, and,
fluid conduits located at each end of the cold plates;
inserting a memory board into the slot between the cold plates; and
pumping a fluid through the conduits to remove heat from the cold plates.

32. The cooling module of claim 17, wherein the means used to enhance thermal contact includes a thermally conductive resilient dielectric material on surfaces of the heat absorbing elements for engaging the memory board.

33. The cooling module of claim 32, wherein the thermally conductive resilient dielectric material is in the form of a thin film.
